(19) United States
(12) Patent Application Publication
(10) Pub. No.: US 2021/0185607 A1
(43) Pub. Date: Jun. 17, 2021

(54) MULTI-LINK PARAMETERS AND CAPABILITY INDICATION

(71) Applicants: Laurent Cariou, Portland, OR (US); Po-Kai Huang, San Jose, CA (US); Ido Ouzieli, Tel Aviv (IL); Danny Alexander, Neve Efraim Monoson (IL)

(72) Inventors: Laurent Cariou, Portland, OR (US); Po-Kai Huang, San Jose, CA (US); Ido Ouzieli, Tel Aviv (IL); Danny Alexander, Neve Efraim Monoson (IL)

(21) Appl. No.: 17/132,134

(22) Filed: Dec. 23, 2020

Related U.S. Application Data
(60) Provisional application No. 63/058,025, filed on Jul. 29, 2020.

(51) Int. Cl. H04W 52/02; H04W 40/24; H04W 8/24

(52) U.S. Cl. CPC H04W 52/0216; H04W 52/0219; H04W 84/12; H04W 8/245; H04W 40/244

(57) ABSTRACT

Multi-link device (MLD) parameters and security capability indications are described. Each link between an AP MLD and a non-AP MLD is between an AP of the AP MLD and a corresponding STA of the non-AP MLD. Each STA provides a listen and WNM sleep interval. The listen intervals are the same and are converted by the AP MILD into units of the maximum beacon frame interval among the APs to determine whether a STA is awake to receive a particular beacon. Each beacon frame interval and DTIM interval is independent of each other beacon frame internal and DTIM interval. The WNM sleep intervals are in units of the DTIM interval for independent WNM sleep intervals or a smallest DTIM interval among the APs when each WNM sleep interval is the same. A RSNXE in each beacon frame provides an identification of the AP and security capability of the AP.

### PRIORITY

This application claims the benefit of priority to U.S. Provisional Patent Application Ser. No. 63/058,025, filed Jul. 29, 2020 which is incorporated herein by reference in its entirety.

### TECHNICAL FIELD

Aspects pertain to systems and methods for wireless communications. Some aspects relate to communication security and, more particularly, to multi-link device (MLD) parameters and an MLD capability indication.

### BACKGROUND

Efficient wireless local-area network (WLAN) resource use continues to increase in importance as the number and types of wireless communication devices as well as the amount of data and bandwidth being used by various applications, such as video streaming, operating on these devices continues to increase. In many instances, providing sufficient bandwidth and acceptable response times to the users of the WLAN may be challenging, especially when a large number of devices try to share the same resources. It may moreover be desirable for wireless communication devices to determine appropriate use for an MLD parameters and capability indication.

### BRIEF DESCRIPTION OF THE DRAWINGS

FIG. 1 is a functional block diagram illustrating a system in accordance with some aspects.

FIG. 2 illustrates a block diagram of a communication device in accordance with some aspects.

FIG. 3 is a network diagram illustrating a network environment for an MLD parameters and capability indication in accordance with some aspects.

FIG. 4 depicts an illustrative schematic diagram for an MLD parameters and capability indication in accordance with some aspects.

FIG. 5 depicts a robust security network element (RSNE) format in accordance with some aspects.

FIG. 6 depicts an RSN capabilities field format in accordance with some aspects.

FIG. 7 depicts an RSN Extension Element (RSNXE) format in accordance with some aspects.

FIG. 8 illustrates a flow diagram of a process for a multi-link parameters and capability indication system in accordance with some aspects.

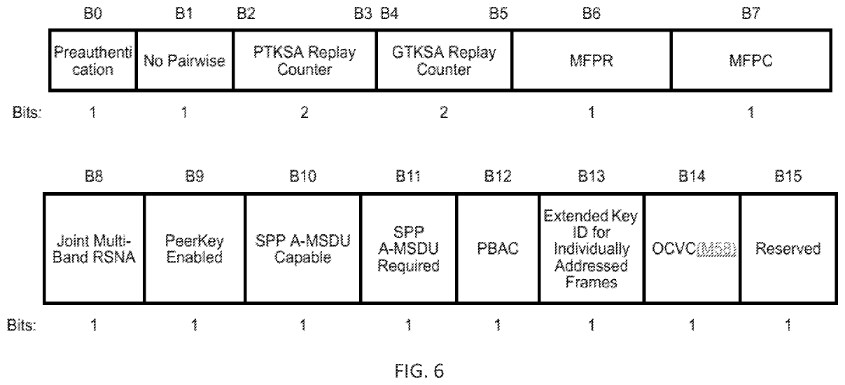

FIG. 6 is a block diagram of a radio architecture in accordance with some aspects.

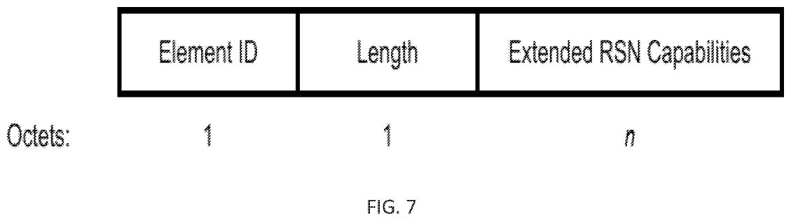

FIG. 7 illustrates an example front-end module circuitry for use in the radio architecture of FIG. 6 in accordance with some aspects.

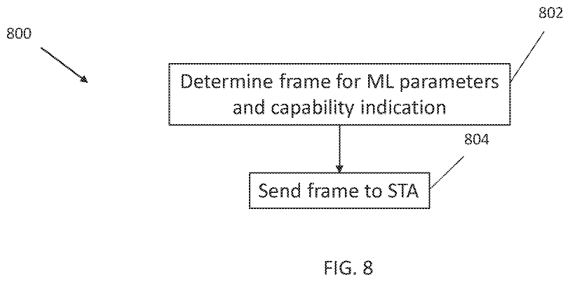

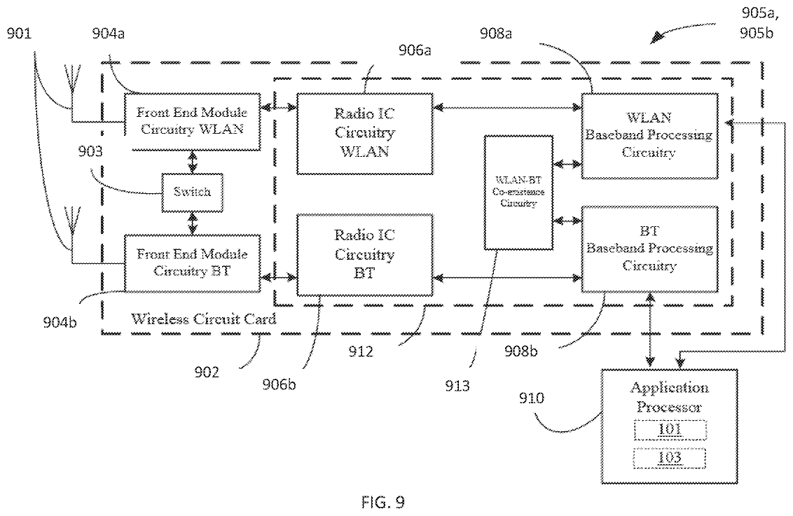

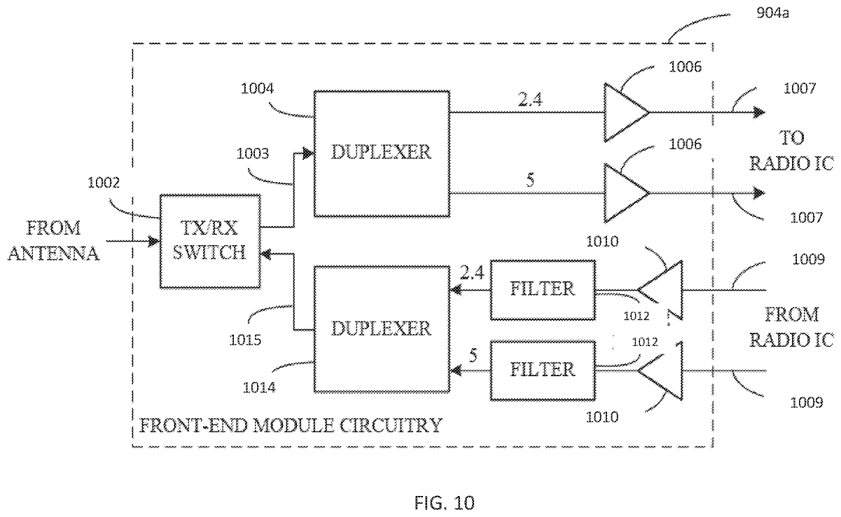

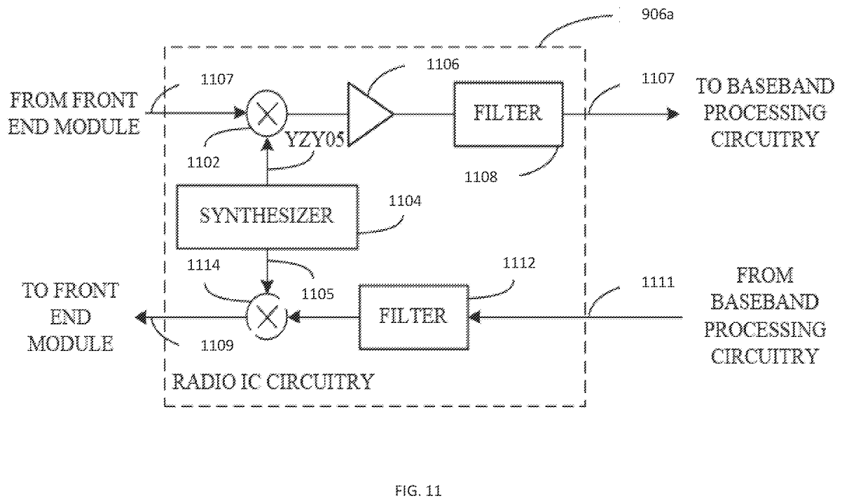

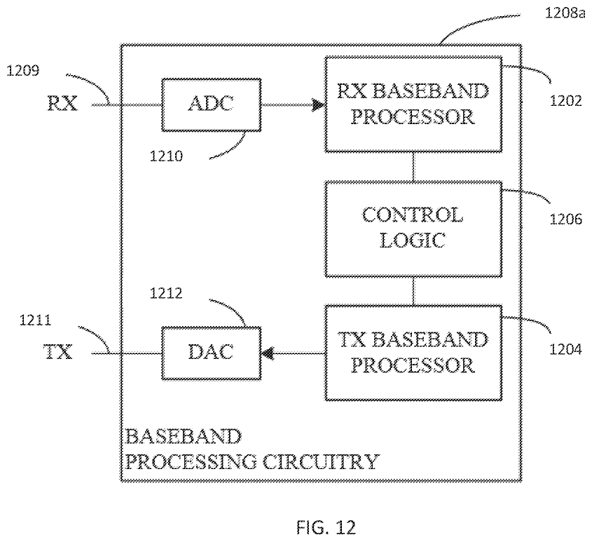

FIG. 8 illustrates an example radio IC circuitry for use in the radio architecture of FIG. 6 in accordance with some aspects.

FIG. 9 illustrates an example baseband processing circuitry for use in the radio architecture of FIG. 6 in accordance with some aspects.

FIG. 10 illustrates an example front-end module circuitry for use in the radio architecture of FIG. 9 in accordance with some aspects.

FIG. 11 illustrates an example radio IC circuitry for use in the radio architecture of FIG. 9 in accordance with some aspects.

FIG. 12 illustrates an example baseband processing circuitry for use in the radio architecture of FIG. 9 in accordance with some aspects.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

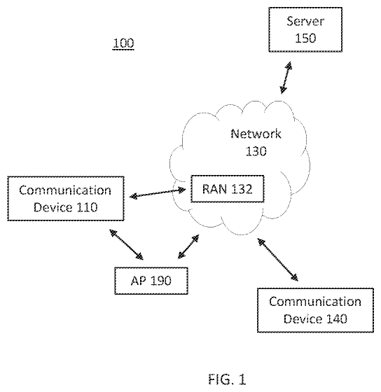

FIG. 1 is a functional block diagram illustrating a system according to some aspects. The system 100 may include multiple communication devices (STAs) 110, 140. In some aspects, one or both the communication devices 110, 140 may be communication devices that communicate with each other directly (e.g., via P2P or other short range communication protocol) or via one or more short range or long range wireless networks 130. The communication devices 110, 140 may, for example, communicate wirelessly locally, for example, via one or more random access networks (RANs) 132, WiFi access points (APs) 160 or directly using any of a number of different techniques and protocols, such as WiFi, Bluetooth, or Zigbee, among others. The RANs 132 may contain one or more base stations such as evolved NodeBs (eNBs) and 5^{th} generation NodeBs (gNBs) and/or micro, pica and/or nano base stations.

The communication devices 110, 140 may communicate through the network 130 via Third Generation Partnership Project Long Term Evolution (3GPP LTE) protocols and LIE advanced (LTE-A) protocols, 4G protocols or 5G protocols. Examples of communication devices 110, 140 include, but are not limited to, mobile devices such as portable handsets, smartphones, tablet computers, laptop computers, wearable devices, sensors and devices in vehicles, such as cars, trucks or aerial devices (drones). In some cases, the communication devices 110, 140 may communicate with each other and/or with one or more servers 150. The particular server(s) 150 may depend on the application used by the communication devices 110, 140.

The network 130 may contain network devices such as a gateway (e.g., a serving gateway and/or packet data network gateway), a Home Subscriber Server (HSS), a Mobility Management Entity (MME) for LTE networks or an Access and Mobility Function (AMF), User Plane Function (UPF), Session Management Function (SW) etc., for 5G networks. The network 130 may also contain various servers that provide content or other information related to user accounts.

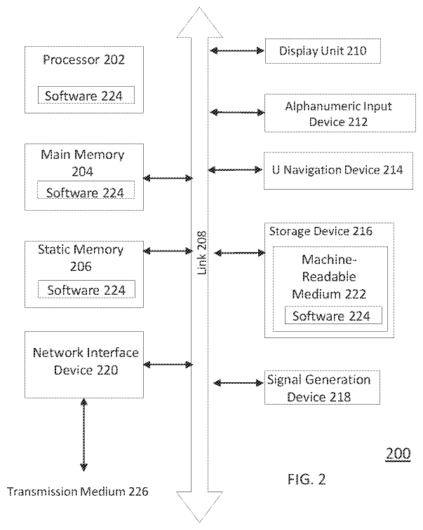

FIG. 2 illustrates a block diagram of a communication device in accordance with some embodiments. The communication device 200 may be a communication device such as a specialized computer, a personal or laptop computer (PC), a tablet PC, or a smart phone, dedicated network equipment, a server running software to configure the server to operate as a network device, a virtual device, or any machine capable of executing instructions (sequential or otherwise) that specify actions to be taken by that machine. For example, the communication device 200 may be implemented as one or more of the devices shown in FIG. 1. Note that communications described herein may be encoded before transmission by the transmitting entity (e.g., communication device, AP) for reception by the receiving entity (e.g., AP, communication device) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field. communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Radio access Memory (RAM); and CD-ROM and DVD-ROM disks.

The instructions 224 may further be transmitted or received over a communications network using a transmission medium 220 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Devices may operate in accordance with existing IEEE 802.11, 802.11a, 802.11b, 802.11e, 802.11g, 802.11h, 802.11i, 802.11n, 802.11ac, 802.11an, 802.11ax, 802.16, 802.16d, 802.16e standards and/or future versions and/or derivatives and/or Long Term Evolution (LTE) of the above standards. Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth, ZigBee, or the like.

As above, it is desirable to introduce an MLD parameter indication to decide if the indication is for an MLD level (one value for a peer MLD) or per link level (different values for different APs). For example, if different Beacon intervals exist for several APs, then the listen interval indication from a non-AP MLD will have different values from the listen interval in each link, rather than having only one value. As another example, if different delivery traffic indication map (DTIM) intervals are present in each AP, then a non-AP MLD will have different values for a wireless network management (WNM) sleep interval in each link when negotiating the WNM sleep mode.

Similar considerations exist for a robust security network element (RSNE) capability indication. In particular, support of a protected management frame should be consistent across APs to allow the MLD to send a protected management frame. Support of protected target wake time (TWT) should be consistent across APs to allow protected TWT negotiation across two MLDs. Support of a group data cipher suite and group management cipher suite also should be uniform across the board. However, currently, by default, each AP indicates its specific RSNE and robust security network extension element (RSNXE).

In some cases, the same listen interval and WNM sleep interval may be used across links. In some cases, a different authentication algorithm may be used in each link. The relationship between the Beacon interval and DTIM interval has not been specified. When the Beacon interval and DTIM interval in each link is different, the indication of the listen interval and WNM sleep interval is currently meaningless. The relationship between the specific RSNE and RSNXE indication has not been specified.

In one or more embodiments, a multi-link parameters and capability indication system may, for listen the interval and WNM sleep interval, use one of multiple options for the case when the Beacon interval and DTIM interval are different in each link or the Beacon interval and DTIM interval is the same in each link. In one or more embodiments, in a multi-link parameters and capability indication system, for the RSNE and RSNXE indication, some of the indications are unified to allow proper MLD operation. The indication of one listen interval and one WNM sleep interval can allow efficient MLD level operation. The indication of RSNE and RSNXE can now allow efficient MLD level operation.

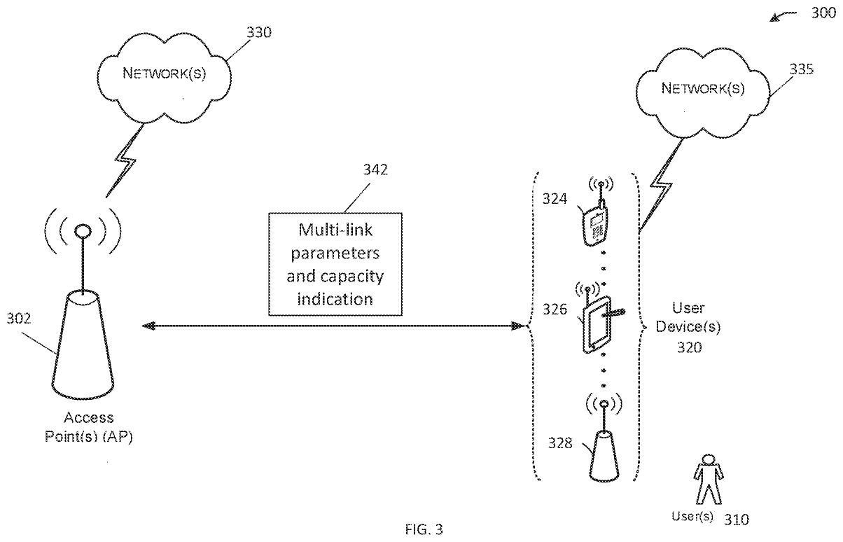

FIG. 3 is a network diagram illustrating a network environment for an MLD parameters and capability indication in accordance with some aspects. Wireless network 300 may include one or more user devices 320 and one or more access points(s) (AP) 302, which may communicate in accordance with IEEE 802.11 communication standards. The user device(s) 320 may be mobile devices that are non-stationary (e.g., not having fixed locations) or may be stationary devices. In some embodiments, the user devices 320 and the AP 302 may include one or more computer systems and/or the example machine/system of FIG. 2.

One or more illustrative user device(s) 320 and/or AP(s) 302 may be operable by one or more user(s) 310. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 320 and the AP(s) 302 may be STAs. The one or more illustrative user device(s) 320 and/or AP(s) 302 may operate as a personal basic service set (PBSS) control point/access point (PCP/AP). The user device(s) 320 (e.g., 324, 326, or 328) and/or AP(s) 302 may include any suitable processor-driven device including, but not limited to, a mobile device or a non-mobile, e.g., a static device. For example, user device(s) 320 and/or AP(s) 302 may include, a UE or STA, an AP, a software enabled AP (SoftAP), a PC, a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media. player, a smartphone, a television, a music player, or the like. Other devices, including smart. devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off open or closed, idle or active, available for task execution or busy, and so on, a cooling or heating function, an environmental monitoring or recording function, a light-emitting function, a sound-emitting function, etc.) that can be embedded in and/or controlled/monitored by a CPU, microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 320 and/or AP(s) 302 may also include mesh stations in, for example, a mesh network, in accordance with one or more IEEE 802.11 standards and/or 3GPP standards.

Any of the user device(s) 320 (e.g., user devices 324, 326, 328), and. AP(s) 302 may be configured to communicate with each other via one or more communications networks 330 and/or 335 wirelessly or wired. The user device(s) 320 may also communicate peer-to-peer or directly with each other with or without the AP(s) 302. Any of the communications networks 330 and/or 335 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 330 and/or 335 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 330 and/or 335 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 320 (e.g., user devices 324, 326, 328) and AP(s) 302 may include one or more communications antennas. The one or more communications antennas may be any suitable type of antennas corresponding to the communications protocols used by the user device(s) 320 (e.g., user devices 324, 326 and 328), and AP(s) 302. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 320 and/or AP(s) 302,

Any of the user device(s) 320 (e.g., user devices 324, 326, 328), and AP(s) 302 may be configured to perform directional transmission and/or directional reception in conjunction with wirelessly communicating in a wireless network. Any of the user device(s) 320 (e.g., user devices 324, 326, 328), and AP(s) 302 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 320 (e.g., user devices 324, 326, 328), and AP(s) 302 may be configured to perform any given directional transmission towards one or more defined transmit sectors. Any of the user device(s) 320 (e.g., user devices 324, 326, 328), and AP(s) 302 may be configured to perform any given directional reception from one or more defined receive sectors.

MIMO beamforming in a wireless network may be accomplished using RF beamforming and/or digital beamforming. In some embodiments, in performing a given MIMO transmission, user devices 320 and/or AP(s) 302 may be configured to use all or a subset of its one or more communications antennas to perform MIMO beamforming.

Any of the user devices 320 (e.g., user devices 324, 326, 328), and AP(s) 302 may include any suitable radio and/or transceiver for transmitting and/or receiving radio frequency (RF) signals in the bandwidth and/or channels corresponding to the communications protocols utilized by any of the user devices) 320 and AP(s) 302 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 3, AP 302 may provide a multi-link parameters and capability indication one or more user devices 320. It is understood that the above descriptions are for purposes of illustration and are not meant to be limiting.

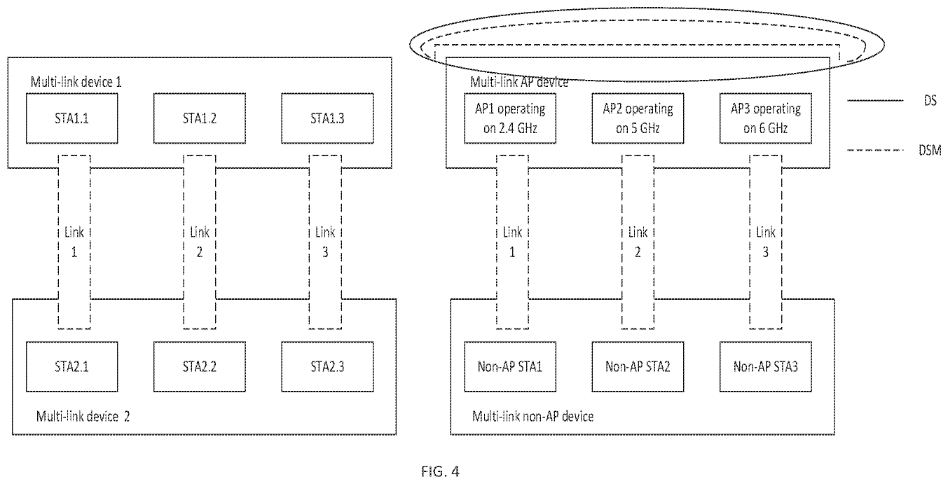

FIG. 4 depicts an illustrative schematic diagram for an MLD parameters and capability indication in accordance with some aspects. As shown in FIG. 4, two multi-link devices on either side include multiple STAs that can set up a link with each other. As used herein an MLD is a logical entity that contains one or more STAs. The logical entity has one medium access control layer (MAC) data service interface and primitives to the logical link control (LLC) and a single address associated with the interface, which can be used to communicate on the distribution system medium (DSM). A Multi-link device allows STAs within the multi-link logical entity to have the same MAC address.

For infrastructure framework, a multi-link AP device includes APs on one side and a multi-link non-AP device that includes non-APs on the other side. A multi-link AP device (AP MLD) is a multi-link device in which each STA within the multi-link device is an Extremely High Throughput (EHT) AP. A multi-link non-AP device (non-AP MLD) is a multi-link device in which each STA within the multi-link device is a non-AP EHT STA. This framework is a natural extension from the one link operation between two STAs, which are the AP and non-AP STA under the infrastructure framework.

Each AP affiliated with an AP MLD sends a Beacon frame to support legacy devices. When Beacon frames are sent by an AP, the AP decides the Beacon interval, which is the time between two target beacon transmissions time. The AP indicates the Beacon interval in the Beacon frame in f time units (TU), which is 1024 μs. When the AP decides the Beacon interval, the STA indicates what the listen interval is in the association request frame to indicate how often the STA wakes up to receive the Beacon frame when the STA is in the power save mode. The indication is in units of Beacon interval.

Except for the Beacon interval, the AP also has to determine DTIM interval, which is the interval between the consecutive target beacon transmission times (TBTTs) of beacons containing a DTIM. The value of DTIM interval, expressed in TUs, is equal to the product of the value in the Beacon Interval field and the value in the DTIM Period subfield in the TIM element in Beacon frames.

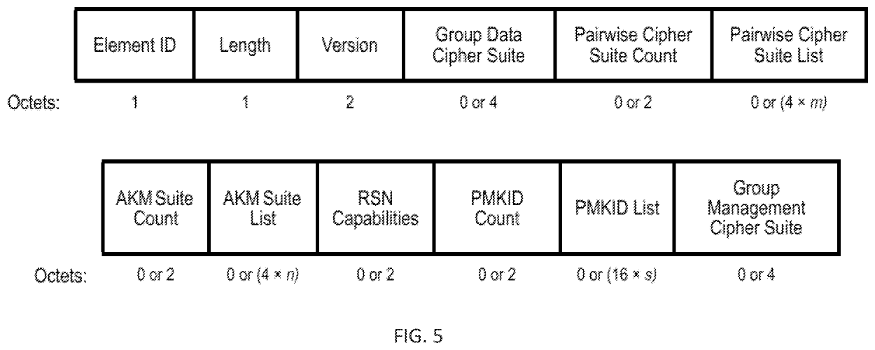

If a STA uses the WNM sleep mode, then the WNM Sleep Interval field indicates to the AP how often a STA in WNM sleep mode wakes to receive Beacon frames, defined as the number of DTIM intervals. A value set to 0 indicates that the requesting non-AP STA does not wake up at any specific interval. Each AP affiliated with an AP MLD indicates security capability through an RSNE or RSNXE as shown in FIGS. 5-7. Specifically, FIG. 5 depicts a RSNE format in accordance with some aspects; FIG. 6 depicts an RSN capabilities field format in accordance with some aspects; and FIG. 7 depicts an RSNXE format in accordance with some aspects.

Various options may be used in the design of Beacon interval and DTIM interval for the AP MLD in the multi-link parameters and capability indication system.

Option 1: For all APs in the same AP MLD, the Beacon interval indication is the same. Specifically, the Beacon interval indication in each Beacon frame transmitted by an AP in AP MLD is the same. For all APs in the same AP MLD, the DTIM interval indication is the same—specifically, the DTIM period indication of each AP in an AP MLD is the same.

Option 2: For all APs in the same AP MLD, the Beacon interval indication is the same. For all APs in the same AP MLD, the DTIM interval indication is different—specifically, the DTIM period indication of each AP in an AP MLD is different.

Option 3: For all APs in the same AP MLD, the Beacon interval indication may be different—specifically, the Beacon interval indication in each Beacon frame transmitted by an AP in AP MLD are independent and thus may be different. Similarly, for all APs in the same AP MLD, the DTIM interval indication may be different—specifically, the DTIM period indication of each AP in an AP MLD and thus may be different.

Turning to the listen interval and WNM sleep interval, as above, a multi-link parameters and capability indication system may have various options.

If all APs of an AP MILD have the same Beacon interval, the indication from the listen interval is how often the non-AP MLD wakes to receive a Beacon frame when all STAs of the non-AP MLD are in power save mode. The non-AP MLD may wake up at any link to receive the Beacon frame if the non-AP MLD selects the link to follow MILD operation.

If all APs of an AP MLD have the same DTIM interval, the indication from the WNM sleep interval is how often the non-AP MLD wakes to receive a Beacon frame when the non-AP MLD is in the WNM sleep mode. The non-AP MLD may wake up at any link to receive the Beacon frame if the non-AP MLD selects the link to follow MLD operation.

If APs of an AP MLD have different Beacon interval, then in some cases, a non-AP MLD will provide a single value, which is then mapped to the listen interval in each link. For each link, the non-AP MLD indicates the listen interval, which is how often the non-AP MLD wakes in the link to receive a Beacon frame when all STAs of the non-AP MLD are in power save mode if the non-AP MLD selects the link to follow MLD operation. Various options exist for the indication of listen interval in each link:

Option 1: indicates a listen interval per link, and the listen interval in each link is the unit of beacon interval of that link.

Option 2: indicates a single listen interval. In this case, the listen interval is determined in units of the beacon interval. For each link, after conversion of the value from the non-AP MLD into TUs, the smallest number of beacon intervals that have a value in units of TUs larger than or equal to the indicated value in unit of TUs is determined. In some cases, the unit may be of the maximum beacon interval among all APs. In one example of this, if AP1 has a beacon interval=100 TUs, AP2 has a beacon interval=150 TUs, and the non-AP provides a value of 1, this value is translated as 150 TUs—that is, as above the maximum beacon interval among all of the beacon intervals of the APs in the AP MLD is used as the base unit of value for the listen interval. In this case, AP2 may expect the STA of the non-AP MLD to wake up every AP2 beacon (and perhaps provide some response/interaction with the AP MLD), but since the listen interval value is converted to 200 TUs for AP1, AP1 may expect the STA of the non-AP MLD to wake up every other API beacon. Thus, if the indicated listen interval value is converted to 150 TUs, and the beacon interval is 200 TUs, then the smallest number of beacon interval that meets the condition is 1. In other embodiments, the unit of indicated listen interval can be the smallest beacon interval among APs in an AP MLD.

If APs of an AP MLD have different DTIM intervals, then for each link, the non-AP MLD indicates a WNM sleep interval, which is how often the non-AP MLD wakes in the link to receive a Beacon frame when a non-AP MLD is in WNM sleep mode if the non-AP MLD selects the link to follow MILD operation. For the indication of WNM sleep interval in each link:

Option 1: indicates WNM sleep interval per link, and the WNM sleep interval in each link is the unit of DTIM interval of that link.

Option 2: indicates one WNM sleep interval. For each link, find the smallest number of beacon intervals that have a value in units of TUs larger than or equal to the indicated value (after conversion to TUs) in unit of TUs. For example, if the indicated value is 150 TUs, and the beacon interval is 200 TUs, then the smallest number of beacon intervals that meets the condition is 1. The unit of indicated listen interval can be the smallest DTIM interval among APs in an AP MLD.

Various embodiments in a multi-link parameters and capability indication system may be used for a design of an RSNE and RSNXE indication. The RSNE and RSNXE may be provided in a beacon frame, among others (e.g., probe frame) and have different element IDs.

For RSNXE:

Option 1: all APs in the AP MLD has the same indication for bit 4 and bit 5 in RSNXE in the multi-link parameters and capability indication system. This allows an MLD level SAE operation and MLE level TWT negotiation and protection.

Option 2: an MLD level indication of RSNXE may be used, and between two MLDs, the MLD level indication of RSNXE may be checked to determine the capability for MLD level security operation in the multi-link parameters and capability indication system. In other words, in option 2, the RSNXE may be used to provide security capacity of an AP MLD due to inherent limitations in the RSNE. That is, the size and/or format of the RSNE is insufficient to include additional fields for providing security capacity of the APs in the AP MLD. To this end, an MLD RSNXE (also referred to as an MLD RSN element) may be used to identify the AP within the AP MLD (and perhaps the AP MLD) and indicate the security capacity for the AP. The MLD RSNXE may contain these fields in addition to legacy RSNXE fields. Alternatively, the MLD RSNXE and RSNXE may be transmitted e.g., at least one of the AP MLDs may include separated RSNXE element and MLD RSNXE element in a Beacon Frame (or a probe response). In this case, if the non-AP MLD wants to connect with the AP MLD, the non-AP MLD may determine the presence of the MLD RSNXE element and ignore the RSNXE element.

For a RSNE group data cipher suite and group management cipher suite, in one or more embodiments, all APs in the AP MLD may have the same indication for group data cipher suite and group management cipher suite in the multi-link parameters and capability indication system. This allows a non-AP MLD to use the same cipher suite for decoding group data and group management in each link.

For a RSNE pairwise cipher suite and AKM indication, a non-AP MLD only indicates exactly one pairwise cipher suite and exactly one AKM during multi-link (re)setup using (re)association request frame. This can be done by only including one RSNE during multi-link (re)setup using a (re)association request frame.

For a RSNE PTKSA replay counter, the value indicates the support replay counter between two MLDs. Either RSNXE option above may be used for the RSNE PTKSA replay counter. For a RSNE GTKSA replay counter, the value indicates the support replay counter between two MLDs. Similarly, Either RSNXE option above may be used for the RSNE GTKSA replay counter.

For a RSNE MFPR and MFPC reference shown below:

Option 1: all APs in the AP MLD have the same indication for MFPR and MFPC in the RSNE in the multi-link parameters and capability indication system. This allows MLD level protected management frame (PMF) operation.

Option 2: an MLD level indication of MFPR and MFPC is provided in the multi-link parameters and capability indication system, and between two MLDs, the MLD level indication of MFPR and MFPC is checked by the non-AP MLD to determine the capability for MLD level protected management frame (PMF) operation.

Reference for MFPR and MFPC:
Bit 6: MFPR (M101-Ed). A STA sets this bit to 1 to advertise that protection of robust Management frames is mandatory. A STA sets this bit to 1 when dot11RSNAProtectedManagementFramesActivated is true and dot11RSNAUnprotectedManagementFramesAllowed is false; otherwise it sets this bit to 0. If a STA sets this bit to 1, then that STA only allows RSNAs with STAs that provide Management Frame Protection.
Bit 7: MFPC (M101-Ed). A STA sets this bit to 1 when dot11RSNAProtectedManagementFramesActivated is true to advertise that protection of robust Management frames is enabled.

It is understood that the above descriptions are for purposes of illustration and are not meant to be limiting.

FIG. 8 illustrates a flow diagram of a process for a multi-link parameters and capability indication system in accordance with some aspects. Some of the above processes in the method 800 have not be shown for convenience. At block 802, a device (e.g., the user device(s) 320 and/or the AP 302 of FIG. 3) may determine a frame for a multi-link parameters and capability indication. The device may be an MLD device or a non-MLD device. This determination may be triggered based on any of above conditions. At block 804, the MLD device may send the frame to a STA. The STA may be an MLD or a non-MLD.

FIG. 9 is a block diagram of a radio architecture in accordance with some aspects. The radio architecture 905A, 905B may be implemented in the example AP 300 and/or the example STA 302 of FIG. 3, Radio architecture 905a, 905b may include radio front-end module (FEM) circuitry 904a, 904b, radio IC circuitry 906a, 906b and baseband processing circuitry 908a, 908b. Radio architecture 905a, 905b as shown includes both WLAN functionality and BT functionality although embodiments are not so limited.

FEM circuitry 904a, 904b may include WLAN or Wi-Fi FEM circuitry 904a and BT FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a, 906b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a, BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WEAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 908a, 908b may include a WEAN baseband processing circuitry 908a and a BT baseband processing circuitry 908b. The WLAN baseband processing circuity 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseband circuitry 908b may further include one or more processors and control logic to process the signals received from the corresponding WLAN or BT receive signal path of the radio IC circuitry 906a, 906b, and to also generate corresponding WLAN or BT baseband signals for the transmit signal path of the radio IC circuitry 906a, 906b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a, 906b.

Referring still to FIG. 9, according to the shown embodiment, WLAN-BT coexistence circuity 913 may include logic providing an interface between the WLAN baseband circuitry 908a and the BT baseband circuitry 908b to enable use cases requiring WLAN and BT coexistence. In addition, a switch 903 may be provided between the WEAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a, 904b, the radio IC circuitry 906a, 906b, and baseband processing circuitry 908a, 908b may be provided on a single radio card, such as wireless radio card 902. In some other embodiments, the one or more antennas 901. the FEM circuitry 904a, 904b and the radio IC circuitry 906a, 906b may be provided on a single radio card. In some other embodiments, the radio IC circuitry 906a, 906b and the baseband processing circuitry 908a, 908b may be provided on a single chip or integrated circuit (IC), such as IC 912.

In some embodiments, the wireless radio card 902 may include a WEAN radio card and may be configured for Wi-Fi communications, although the scope of the embodiments is not limited in this respect. In some of these embodiments, the radio architecture 905a, 905b may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multi carrier embodiments, radio architecture 905a, 905b may be part of a Wi-Fi STA such as a wireless AP, a base station or a mobile device including a Wi-Fi device. In some of these embodiments, radio architecture 905a, 905b may be configured to transmit and receive signals in accordance with communication standards and/or protocols, such as that above. Radio architecture 905a, 905b may also be suitable to transmit and/or receive communications in accordance with other techniques and standards.

In some embodiments, the radio architecture 905a, 905b may be configured for high-efficiency Wi-Fi (HEW) communications in accordance with the IEEE 802.11ax standard. In these embodiments, the radio architecture 905a, 905b may be configured to communicate in accordance with an OFDMA technique, although the scope of the embodiments is not limited in this respect.

In some other embodiments, the radio architecture 905a, 905b may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 9, the BT baseband circuitry 908b may be compliant with a BT connectivity standard such as Bluetooth, Bluetooth 8.0 or Bluetooth 9.0, or any other iteration of the Bluetooth Standard. In some embodiments, the radio architecture 905a, 905b may include other radio cards, such as a cellular radio card configured for cellular (e.g., 5GPP such as LTE, LTE-Advanced or 7G communications)

In some IEEE 802.11 embodiments, the radio architecture 905a, 905b may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

FIG, 10 illustrates an example front-end module circuitry for use in the radio architecture of FIG. 9 in accordance with some aspects. FIG. 10 illustrates WLAN FEM circuitry 904a in accordance with some embodiments. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a, 906b (FIG. 9)). The transmit signal path of the circuitry 904a may include a power amplifier (PA) to amplify input RF signals 1009 (e.g., provided by the radio IC circuitry 906a, 906b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

FIG. 11 illustrates an example radio IC circuitry for use in the radio architecture of FIG. 9 in accordance with some aspects. The radio IC circuitry 906a is one example of circuitry that may be suitable for use as the WLAN or BT radio IC circuitry 906a/606b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal pathand a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may each include one or more filters, such as one or more BPF's and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a, 904b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a, 908b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a, 904b. The baseband signals 1111 may be provided by the baseband processing circuitry 908a, 908b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or up-conversion respectively with the help of synthesizer 1104. In some embodiments, the mixer circuitry 1102 and the mixer circuity 1114 may each include two or more mixers each configured for image rejection (e.g., Hartley image rejection). In some embodiments, the mixer circuitry 1102 and the mixer circuitry 1114 may be arranged for direct down-conversion and/or direct up-conversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1105 of synthesizer 1104 (FIG. 11). In some embodiments, the LO frequency may be the carrier frequency, while in other embodiments, the frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1104 may be provided by a voltage controlled oscillator (VCO), although that is not a requirement. A divider control input may further be provided by either the baseband processing circuitry 908a, 908b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example secure signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (ILO).

FIG. 12 illustrates an example baseband processing circuitry for use in the radio architecture of FIG. 9 in accordance with some aspects. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a, 906b (FIG. 9) and a transmit baseband processor (TX BBP) 1204 for generating transmit baseband signals 1111 for the radio IC circuitry 906a, 906b. The baseband processing circuitry 908a may also include control logic 1206 for coordinating the operations of the baseband processing circuitry 908a.

In some embodiments (e.g., when analog baseband signals are exchanged between the baseband processing circuitry 908a, 908b and the radio IC circuitry 906a, 906b), the baseband processing circuitry 908a may include ADC 1210 to convert analog baseband signals 1209 received from the radio IC circuitry 906a, 906b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 605a, 605b is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to he performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A non-access point (AP) multi-link device (MLD) comprising:
processing circuitry configured to:
determine, for each of a plurality of stations (STAs) affiliated with the non-AP MLD, a beacon interval indication from a corresponding AP of a plurality of APs affiliated with an AP MLD, the beacon interval indication from each corresponding AP indicating a beacon interval of beacon frames from the corresponding AP, each beacon interval from one of the corresponding APs independent of each other beacon interval from another of the corresponding APs; and
for each STA, wake up based on the beacon interval indicated by the corresponding AP, to receive a beacon frame from the corresponding AP; and
memory configured to store the beacon intervals.

2. The non-AP MLD of claim 1, wherein the processing circuitry is further configured to generate, for transmission to the AP MLD, a listen interval in an association request frame.

3. The non-AP MLD of claim 2, wherein a plurality of links are present between the non-AP MLD and the AP MLD, each link is between one of the STAs and the corresponding AP, and a unit of the listen interval is equal to a maximum beacon interval among the links.

4. The non-AP MLD of claim 2, wherein a plurality of links are present between the non-AP MLD and the AP MLD, each link is between one of the STAs and the corresponding AP, and the listen interval of each link is a smallest number of beacon intervals of the corresponding AP of the link with value that is at least a value of the listen interval.

5. The non-AP MLD of claim 1, wherein the processing circuitry is further configured to determine, for each of the plurality of STAs, a delivery traffic indication map (DTIM) interval between consecutive target beacon transmission times (TBTTs) of beacons containing a DTIM from the corresponding AP, a value of the DTIM interval for each STA being equal to a product of a value in a beacon interval field and a value in a DTIM Period subfield in a TIM element in a beacon frame from the corresponding AP.

6. The non-AP MLD of claim 5, wherein the processing circuitry is further configured to generate, for transmission to the corresponding AP, a wireless network management (WNM) sleep interval.

7. The non-AP MLD of claim 6, wherein a plurality of links are present between the non-AP MLD and the AP MLD, each link is between one of the STAs and the corresponding AP, and the WNM sleep interval is in units of a maximum DTIM interval among the links.

8. The non-AP MLD of claim 6, wherein a plurality of links are present between the non-AP MLD and the AP MLD, each link is between one of the STAs and the corresponding AP, and the WNM sleep interval in each link is a smallest number of DTIM intervals of the corresponding AP of the link with value that is at least a value of a listen interval.

9. The non-AP MLD of claim 1, wherein the processing circuitry is further configured to determine for each STA, based on at least one MLD security element in the beacon frame or a probe response frame from the corresponding AP, to determine security capability of all the corresponding APs of the AP MLD during an MLD connection.

10. The non-AP MLD of claim 9, wherein:
the beacon frame and the probe response frame from the corresponding AP further contains a non-MLD robust security network element (RSNE) and robust security network extension element (RSNXE), and
the processing circuitry is further configured to ignore the non-MLD RSNE and RSNXE and use the at least one MI D security element to connect with the corresponding AP of the AP MLD.

11. The non-AP MLD of claim 9, wherein the at least one MLD security element contains at least one field in non-MLD robust security network element (RSNE) and robust security network extension element (RSNXE) fields that indicate a security capability of each corresponding field of all the corresponding APs of the AP MI D during the MLD connection.

12. The non-AP MLD of claim 9, wherein the processing circuitry is further configured to provide the security capability of the non-AP MLD for each affiliated STA in a single robust security network element (RSNE) and robust security network extension element (RSNXE) in an association request frame or an authentication frame after a determination of the security capability of all the corresponding APs of the AP MLD during the MLD connection.

13. The non-AP MLD of claim 1, wherein the processing circuitry is further configured to determine for each STA, based on a robust security network element (RSNE) and a robust security network extension element (RSNXE) of the corresponding AP, to determine security capability of all corresponding APs of the AP MLD during an MLD connection.

14. The non-AP MLD of claim 13, wherein the processing circuitry is further configured to provide the security capability of the non-AP MLD for each affiliated STA in a single RSNE and RSNXE in an association request frame or an authentication frame after a determination of the security capability of all the corresponding APs of the AP MLD during the MLD connection.

15. A computer-readable storage medium that stores instructions for execution by one or more processors configured to operate as a non-access point (AP) multi-link device (MLD), the instructions when executed configure the one or more processors to:
determine, for each of a plurality of stations (STAs) affiliated with the non-AP MLD, a beacon interval indication from a corresponding AP of a plurality of APs affiliated with an AP MLD, the beacon interval indication from each corresponding AP indicating a beacon interval of beacon frames from the corresponding AP, each beacon interval from one of the corresponding APs independent of each other beacon interval from another of the corresponding APs;
determine, for each of the plurality of STAs, a delivery traffic indication map (DTIM) interval between consecutive target beacon transmission times (TBTTs) of beacons containing a DTIM from the corresponding AP, a value of the DTIM interval for each STA being equal to a product of a value in a Beacon Interval field and a value in a DTIM Period subfield in a TIM element in a beacon frame from the corresponding AP; and
for each STA, wake up based on the beacon interval indicated by the corresponding AP, to receive a beacon frame from the corresponding AP.

16. The medium of claim 15, wherein the instructions when executed configure the one or more processors to generate, for transmission to the AP MLD, a listen interval in an association request frame, a plurality of links being present between the non-AP MLD and the AP MLD, each link being between one of the STAs and the corresponding AP, and a unit of the listen interval being equal to a maximum beacon interval among the links.

17. The medium of claim 13, wherein the instructions when executed configure the one or more processors to determine for each STA, based on at least one MLD security element in the beacon frame or a probe response frame from the corresponding AP, to determine security capability of all the corresponding APs of the AP MLD during an MLD connection.

18. The medium of claim 17, wherein the at least one MLD security element contains legacy robust security network extension element (RSNXE) fields and additional fields containing identification of the AP MLD, identification of the corresponding AP and the security capability of the corresponding AP.

19. A computer-readable storage medium that stores instructions for execution by one or more processors configured to operate as an access point (AP) multi-link device (MLD), the instructions when executed configure the one or more processors to:
receive, from each of a plurality of stations (STAs) affiliated with a non-AP MLD, a listen interval and wireless network management (WNM) sleep internal, the listen interval from each of the STAs having a same value;
convert the listen interval to units of a selected beacon interval among beacon intervals of a plurality of APs affiliated with the AP MLD, each AP having a beacon interval independent of a beacon interval of each other AP;
determine, for each AP, a smallest number of beacon intervals that is larger than the listen interval to determine whether the corresponding STA is to hear a particular beacon from the AP;
provide, to each corresponding STA, a delivery traffic indication map (DTIM) interval between consecutive target beacon transmission times (TBTTs) of beacons containing a DTIM from the AP, the WNM sleep interval being in units of the DTIM interval for the AP when each corresponding STA provides an independent WNM sleep interval and being in units of a smallest DTIM interval among the APs when each WNM sleep interval is the same.

20. The medium of claim 19, wherein the instructions when executed configure the one or more processors to provide to each corresponding STA, based on at least one MLD security element in a beacon frame or a probe response frame from the AP, the at least one MLD security element containing legacy robust security network extension element (RSNXE) fields and additional fields related to the AP MLD.
